(19) United States
(12) Patent Application Publication
(10) Pub. No.: US 2008/0236308 A1
(43) Pub. Date: Oct. 2, 2008

(54) Dummy body for testing sitting, reclining and supporting cushions of upholstered furniture

(76) Inventors: Ingo Liebelt, Suderburg (DE); Michael Schultz, Gifhorn (DE); Detlef Zottmann, Gifhorn (DE)

Correspondence Address: COLLARD & ROE, P.C., 1077 NORTHERN BOULEVARD, ROSLYN, NY, 11576, US

(21) Appl. No.: 11/823,761

(22) Filed: Jun. 28, 2007

(30) Foreign Application Priority Data
Jun. 28, 2006 (DE) DE1020006030345.8

(51) Int. Cl. G01M 19/00

(52) U.S. Cl. 73/866.4

(57) ABSTRACT

A dummy body for testing of sitting, reclining and supporting cushions of upholstered sitting and reclining furniture, by means of which a complex interaction of various muscles can be simulated, true to reality, in a variable way, and which is distinguished by a cost-effective and simple construction. The worn parts can be replaced quickly and cost-effectively. The dummy body has a plurality of discs arranged adjustably next to one another and having different material properties in terms of the degree of hardness. Therefore, the muscle hardness of a dummy body to be simulated can be set variably according to a predetermined test program.

### BACKGROUND OF THE INVENTION

1. Field of the Invention

The invention relates to a dummy body for testing sitting, reclining and supporting cushions of upholstered furniture.

2. The Prior Art

German Patent No. DE 196 01 974 A1 describes a method for judging the sitting comfort of a seat cushion which is subjected to mechanical load. Loading may be carried out by persons of different size or takes place by means of a specially configured pressure ram which is pressed into the vehicle seat to be tested. During loading, the pressure distribution on the sitting surface or on the backrest surface is determined by a measuring mat laid between the seat and the pressure ram.

German Patent Nos. DE 196 01 971 C2 and DE 198 10 641 C1 describe devices for judging the sitting comfort of a seat cushion via a specially configured seat test ram being pressed into the vehicle seat to be tested. The shape of the ram ensures a loading of the seat which is as true to reality as possible. The seat test ram in this case copies the pelvis and the thigh, including the thigh joints, of a human skeleton. The seat test ram is provided with overupholstery, so that it copies, true to nature, the pelvic and thigh region of a human body in terms of the skeleton and the muscular, connective and fatty tissue. By means of the device according to German Patent No. DE 198 10 641 C1, two exchangeable pressure pieces are brought selectively into the same working position.

The prior art has the disadvantage that, to implement different muscle hardnesses, in particular the tensed and the relaxed muscle state, different seat test rams have to be used for the testing of seat systems. The multiplicity of test rams required for this purpose increases the cost of the test series considerably. A further disadvantage is that, after a corresponding number of test runs, the test bodies undergo wear and therefore have to be exchanged or replaced completely.

### SUMMARY OF THE INVENTION

It is therefore an object of the invention to develop a dummy body for the testing of sitting, reclining and supporting cushions of upholstered furniture, by means of which a complex interaction of various muscles can be simulated, true to reality, in a variable way, and which is distinguished by a cost-effective and simple construction, and the worn parts of which can be replaced quickly and cost-effectively.

This object is achieved, according to the invention, by a dummy body comprising a plurality of individually adjustable discs arranged next to one another longitudinally or transversely with respect to the bearing surface of a piece of sitting or reclining furniture. There is at least one disc consisting of softer material arranged between two discs consisting of a harder material.

Due to the arrangement of a plurality of discs arranged adjustably next to one another longitudinally or transversely with respect to the sitting or reclining surface and having different material properties in terms of the degree of hardness, the muscle hardness of a dummy body to be simulated can be set variably according to a predetermined test program.

By the individual discs of the dummy body being displaced relative to one another, the hardness of the dummy body is set and simulated according to the actual muscular build of a person. Actuators arranged correspondingly on the individual discs allows this adjustment to be carried out in the test phase. The tensing of the muscles in the movement phase can be reset by programming.

A further advantage of the invention is if the softer discs simulating the muscular, connective and fatty tissue suffer from material wear, they can be exchanged or replaced quickly and simply. Costs arising due to wear can thus be minimized by the exchange of individual worn discs. It is therefore no longer necessary to exchange a complete seat test body.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a diagrammatic illustration of one embodiment of the dummy body in a perspective view;

FIG. 2 shows a detail of an embodiment of the dummy body of the invention in an exploded illustration;

FIG. 3 shows a front view of an embodiment of the dummy body according to the invention, in section, in the simulation of a firm muscular tissue; and

FIG. 4 shows a front view of an embodiment of the dummy body according to the invention, in section, in the simulation of a soft muscular tissue.

### DETAILED DESCRIPTION OF THE PREFERRED EMBODIMENT

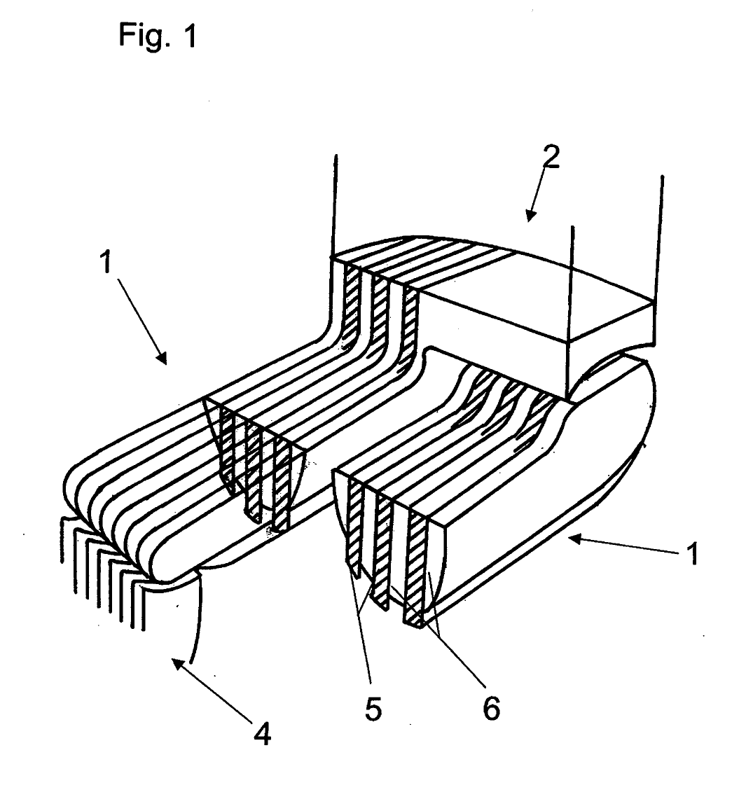

FIG. 1 illustrates part of a dummy body consisting of a thigh 1, pelvic region 2 and lower leg 4, such as is also used in the testing of sitting, reclining and supporting cushions of upholstered sitting and reclining furniture 3. The sitting and reclining furniture 3 may be vehicle seats, upholstered furniture, such as armchairs, sofas, couches, beds and the like. The dummy body can be extended to include the back and head region and the arms, for testing the sitting, reclining and supporting cushions, according to the planned conduct of the tests for testing upholstered sitting and reclining furniture 3. The dummy body is provided with joints, known per se, by means of which the movement sequences of a human skeleton can be simulated. The dummy body is covered, overall, by a material, not illustrated, in the form of a plastic film or other skin-like material. In order to obtain results true to reality, the dummy body may be lined with textile materials.

According to the invention, the dummy body consists of a plurality of discs 5 and 6 arranged next to one another longitudinally or transversely with respect to the bearing surface of a piece of sitting or reclining furniture 3. Discs 5 have a different material hardness from that of the discs 6, so that, as a result of the interaction of hard and soft layers, regions of different hardness of the human body and of the muscles can be illustrated. Discs 5 consist of a material which is softer than that of discs 6. Each of discs 5 consisting of softer material are arranged between two discs 6 consisting of a harder material. The number and arrangement of the respective discs 5 and 6 depend on the structure of the muscles or body parts to be simulated and on their direction of movement. Discs 5 and 6 can be adjusted in the direction of the bearing surface of the dummy body on the piece of sitting or reclining furniture 3 in the disc plane of discs 5 or 6.

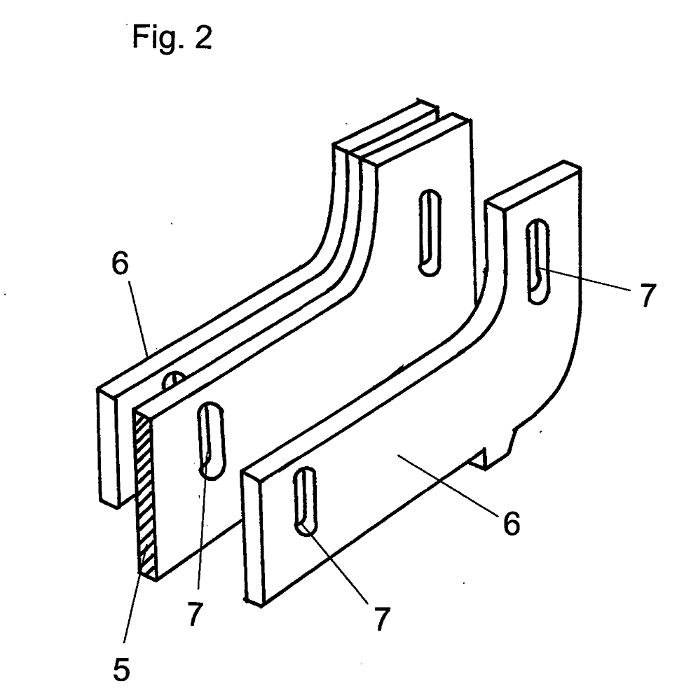

Adjustment by the displacement of discs 5 and 6 in relation to one another takes place either manually or by actuators, not illustrated. As illustrated in FIG. 2, long holes 7 are arranged in discs 5 and 6 to guide discs 5 and 6. Bolts are guided in long holes 7 and are connected firmly to outer discs 6. During manual adjustment, for example, screws, by means of which the bracing of, for example, the thigh 1 takes place, are led through long holes 7. According to the kinematic movement of the dummy body, single discs or all discs 5 and 6 are adjusted identically or differently to one another by means of the actuators or by manual adjustment, so that both tensed and relaxed muscle regions can be simulated.

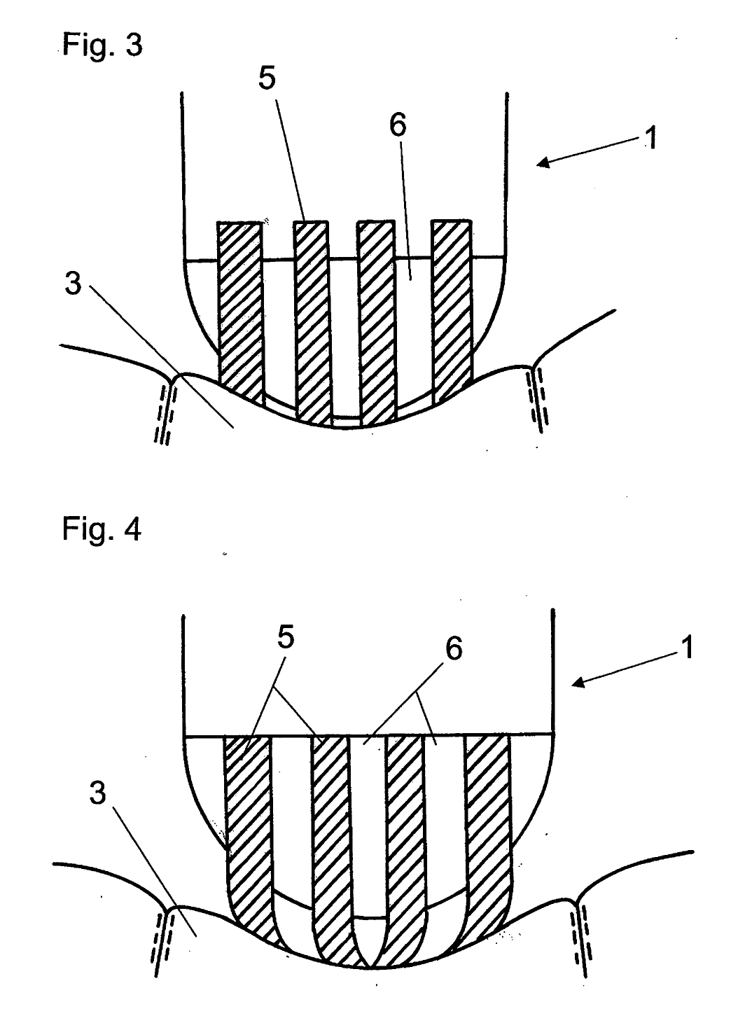

To simulate the active muscle regions, both the harder discs 6 and the softer discs 5 can have identical or different material hardnesses. FIG. 3 illustrates a thigh 1 in cross section, in which softer discs 5 have been adjusted only slightly with respect to harder discs 6. A firm muscular structure can consequently be illustrated. FIG. 4 illustrates a thigh 1 which has a softer muscular structure than shown in FIG. 3. The softer discs 5 have in this case been displaced further outwards with respect to harder discs 6 in the direction of the sitting surface of sitting or reclining furniture 3. The illustration of the muscular structure can be further varied by different material hardnesses of single discs or all discs 5 and 6. Softer discs 5 preferably consist of a corresponding plastic, while harder discs 6 consist of a harder plastic or of metal, for example aluminum. However, other materials may also be used, which take into account a correspondingly desired material hardness for simulating the skeleton and the muscular, connective and fatty tissue of a human body. For a further refinement in the simulation of the muscle action, discs 5 and/or 6 may be subdivided in their longitudinal direction into one or more individual portions, the individual portions being separately adjustable.

By the dummy body being built up by means of a plurality of discs 5 and 6 arranged next to one another, there is also the possibility of arranging measuring probes and/or measurement transducers at any desired location on and between discs 5 and 6. The measurement results of the test can thereby be documented accurately.

Discs 5 and/or 6 may also be provided with a heating device. In the conduct of tests at low temperatures, therefore, a uniform hardness of the disc set and consequently of the muscular structure of the body to be simulated is ensured.

Discs 5 and 6 are exchangeable, so that, in the event of wear of softer discs 5 in particular, these can be exchanged without difficulty. So that a corresponding wear of discs 5 can be determined, they are provided with a profile on the side of contact with the piece of sitting or reclining furniture 3. If a predetermined profile depth is undershot, these discs 5 must be exchanged. The costs of wear can thereby be reduced appreciably, since only individual worn discs have to be exchanged, and an entire subassembly does not have to be replaced.

The dummy body constructed according to the invention may, of course, be employed in corresponding vehicle crashes.

Accordingly, while only a few embodiments of the present invention have been shown and described, it is obvious that many changes and modifications may be made thereunto without departing from the spirit and scope of the invention.

### LIST OF REFERENCE SYMBOLS USED

1 Thigh
2 Pelvic region
3 Sitting or reclining furniture
4 Lower leg
5 Disc
6 Disc
7 Long hole

What is claimed is:

1. A dummy body for testing sitting, reclining and supporting cushions of upholstered furniture by placing the dummy body on the furniture to be tested and which simulates a human skeleton and soft parts by the arrangement of molded pieces having different material hardnesses, the dummy body comprising:
a plurality of individually adjustable discs arranged next to one another longitudinally or transversely with respect to a bearing surface of the furniture to be tested, at least one disc consisting of softer material than a material of the other discs which consist of a harder material, each of said at least one disc of softer material being arranged between two discs consisting of the harder material.

2. A dummy body according to claim 1, wherein said at least one disc consisting of a softer material and the discs consisting of a harder material are adjustable in a direction of a bearing surface of the dummy body on the furniture in a disc plane of the discs.

3. A dummy body according to claim 2, wherein the discs are adjusted manually or by means of actuators.

4. A dummy body according to claim 1, wherein said at least one softer disc has variably selectable material hardnesses.

5. A dummy body according to claim 1, wherein said harder discs have variably selectable material hardnesses.

6. A dummy body according to claim 1, wherein a simulation of different muscle hardnesses can be set in the dummy body by varying an amount of displacement of said at least one softer disc with respect to the harder discs, and by using discs having different hardnesses.

7. A dummy body according to claim 1, wherein the discs are exchangeable.

8. A dummy body according to claim 1, wherein measuring probes and/or measurement transducers are arranged at any desired location on and between the discs.

9. A dummy body according to claim 1, wherein the discs are provided with long holes.

10. A dummy body according to claim 1, wherein said at least one softer disc consists of a plastic material and the harder discs consist of metal or a plastic material that is harder than the plastic material of the at least one softer disc.

11. A dummy body according to claim 1, further comprising a skin-like material covering the dummy body.

12. A dummy body according to claim 1, wherein the dummy body is lined with a textile material.

13. A dummy body according to claim 1, further comprising tensioning means for bracing the discs with one another.

14. A dummy body according to claim 13, wherein the bracing means comprises screws threaded through long holes in the discs and secured with nuts.

15. A dummy body according to claim 1, wherein the discs can be adjusted variably with respect to one another.

16. A dummy body according to claim 1, wherein the dummy body is constructed to have thighs, a pelvic region, a back region and arms, and wherein the thighs are adapted to be placed onto a sitting surface of a seat, the pelvic region and the back region of the dummy body are adapted to be placed against a backrest and the arms are adapted to be placed on arm-rests.

17. A dummy body according to claim 1, wherein the discs are subdivided in a longitudinal direction into a plurality of individually adjustable portions.

18. A dummy body according to claim 1, wherein the discs are provided with a heating device.

19. A dummy body according to claim 1, wherein the softer discs are provided with a profile on a side that contacts the furniture.
